(19) United States
(12) Patent Application Publication
(10) Pub. No.: US 2007/0059580 A1
(43) Pub. Date: Mar. 15, 2007

(54) Design strategies for corrosion mitigation

(76) Inventors: Michael K. Budinski, Pittsford, NY (US); Brian K. Brady, North Chili, NY (US); Hubert A. Gasteiger, Rochester, NY (US); Keith E. Newman, Pittsford, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/227,771

(22) Filed: Sep. 15, 2005

(51) Int. Cl. H01M 2/08; H01M 4/94; H01M 8/02

(52) U.S. Cl. 429/35; 429/44; 429/38

(57) ABSTRACT

Fuel cells are provided that are at least partially resistant to corrosion, including the use of components that are comprised of materials that are at least partially resistant to corrosion. The fuel cells include subgasket materials and designs, involving geometric arrangements of the subgasket that reduce oxygen permeation from, the cathode to the anode side of the membranes and/or hydrogen permeation from the anode to the cathode side of the membranes. In addition to using protonically non-conductive subgasket materials with lower oxygen and/or hydrogen permeabilities, versus ionomeric subgaskets which are protonically conducting and have high O₂ permeation rates, the elimination of the microporous layer (e.g., coated onto the diffusion medium) directly beneath the permeable subgasket materials will also reduce production of corrosive species. The elimination of direct contact between the bipolar plate material surface and PFSA ionomer membrane material also prevents corrosion to the metal bipolar plates.

### BACKGROUND OF THE INVENTION

1. Field of the Invention

The present invention relates generally to fuel cell systems, and more particularly to new and improved membrane electrode assemblies of fuel cell systems.

2. Discussion of the Related Art

Fuel cells have been used as a power source in many applications. For example, fuel cells have been proposed for use in electrical vehicular power plants to replace internal combustion engines. In PEM-type fuel cells, hydrogen is supplied to the anode of the fuel cell and oxygen is supplied as the oxidant to the cathode. PEM fuel cells include a membrane electrode assembly (MEA) comprising a thin, proton transmissive, non-electrically conductive solid polymer electrolyte membrane having the anode catalyst on one of its faces and the cathode catalyst on the opposite face. The MEA is sandwiched between a pair of electrically conductive elements, sometimes referred to as the gas diffusion media components, that: (1) serve as current collectors for the anode and cathode; (2) contain appropriate openings therein for distributing the fuel cell's gaseous reactants over the surfaces of the respective anode and cathode catalysts; (3) remove product water vapor or liquid water from electrode to flow field channels; (4) are thermally conductive for heat rejection; and (5) have mechanical strength. The term fuel cell is typically used to refer to either a single cell or a plurality of cells (e.g., a stack) depending on the context. A plurality of individual cells are commonly bundled together to form a fuel cell stack and are commonly arranged in series. Each cell within the stack comprises the MEA described earlier, and each such MEA provides its increment of voltage.

In PEM fuel cells, hydrogen (H₂) is the anode reactant (i.e., fuel) and oxygen is the cathode reactant (i.e., oxidant). The oxygen can be either a pure form (O₂), or air (a mixture of O₂ and N₂). The proton-conducting solid polymer electrolytes are typically made from ion exchange resins such as perfluorinated sulfonic acid (“PFSA”) based ionomers or hydrocarbon based (non-fluorinated or partially fluorinated) proton-conducting polymers (e.g., sulfonated polyether etherketone (SPEEK)). The anode/cathode electrodes typically comprise finely divided catalytic particles, which are often supported on carbon particles, and mixed with a proton-conductive resin. The catalytic particles are typically costly precious metal particles. These membrane electrode assemblies are relatively expensive to manufacture and require certain conditions, including proper water management and humidification, and control of catalyst fouling constituents such as carbon monoxide (CO), for effective operation.

Examples of technology related to PEM and other related types of fuel cell systems can be found with reference to commonly-assigned U.S. Pat. No. 3,985,578 to Witherspoon et al.; U.S. Pat. No. 5,272,017 to Swathirajan et al.; U.S. Pat. No. 5,624,769 to Li et al.; U.S. Pat. No. 5,776,624 to Neutzler; U.S. Pat. No. 6,277,513 to Swathirajan et al.; U.S. Pat. No. 6,350,539 to Woods, III et al.; U.S. Pat. No. 6,372,376 to Fronk et al.; U.S. Pat. No. 6,521,381 to Vyas et al.; U.S. Pat. No. 6,524,736 to Sompalli et al.; U.S. Pat. No. 6,566,004 to Fly et al.; U.S. Pat. No. 6,663,994 to Fly et al.; U.S. Pat. No. 6,793,544 to Brady et al.; U.S. Pat. No. 6,794,068 to Rapaport et al.; U.S. Pat. No. 6,811,918 to Blunk et al.; U.S. Pat. No. 6,824,909 to Mathias et al.; U.S. Pat. No. 6,861,173 to Bhaskar et al.; U.S. Patent Application Publication Nos. 2003/0165731 to Vyas et al.; 2004/0067407 to Sompalli et al.; 2004/0081881 to Vyas et al.; 2004/0110058 to Lee et al.; 2004/0151952 to Brady et al.; 2004/0208989 to Lee et al.; 2005/0026012 to O'Hara; 2005/0026018 to O'Hara et al.; 2005/0026523 to O'Hara et al., 2005/0037212 to Budinski; and 2005/0058881 to Goebel et al., the entire specifications of all of which are expressly incorporated herein by reference.

One problem that has been encountered concerns bipolar plate corrosion (particularly for metallic bipolar plates) involving the MEA or in proximity to the MEA, which could potentially impair the function and/or efficiency of the fuel cell. For example, oxygen permeates (referred to as “oxygen crossover”) from the cathode side of a MEA through the membrane, or, in the case where a membrane protecting layer (referred to as “subgasket”) is applied in the edge-region of the MEA, through the membrane and the subgasket, to the anode side of the MEA. Catalyzed by the carbon-supported platinum catalyst (Pt/C) on the anode side of the MEA, crossover oxygen reacts with protons from the proton-conducting polymer in an electrochemical reaction yielding a small fraction of hydrogen peroxide (O₂+2H⁺+2e⁻→H₂O₂). This reaction is also catalyzed by the high surface area carbon coating commonly applied to the anode diffusion media (“DM”) (often referred to as the microporous layer or “MPL”) or, less effectively, by the carbon fibers and carbon fillers of the DM substrate (see FIG. 1). Additionally, O₂ permeation to the anode side can yield HF, via the following reaction: (O₂+H₂ →HF) (see FIG. 1). Furthermore, H2 permeation to the cathode side can also yield HF, via the following reaction: (O₂+H₂→HF) (see FIG. 1).

It is found by rotating ring disk experiments in aqueous acids that the fraction of O₂ which gets reduced electrochemically on the anode to H₂O₂ is larger if catalyzed by high surface area carbon as compared to a carbon-supported platinum catalyst (see FIG. 2). In the boundary regions of the MEA, i.e., where there are no more gas-supplying flow-field channels and/or where the MEA will come into contact with the perimeter seal (generally elastomers), neither catalyst nor an MPL are required, but depending on the design of the MEA, Pt/C and/or MPL may be present in these regions. Most MEA designs, however, incorporate a subgasket in the above described boundary region that differentiates the area of the MEA involved in electrochemical processes from that area which does not take part in useful electrochemical processes.

In some instances, the subgasket is comprised of the same PFSA ionomer that is used in the catalyst-containing section of the MEA. This ionomer exhibits relatively high oxygen permeability and is a good proton conductor. Once the oxygen permeates through the subgasket, it will come in contact with hydrogen on the anode side of the membrane. Normally this will result in formation of water, as well as a minute amount of hydrogen peroxide. The branching ratio of water to peroxide is controlled by the presence or absence of a suitable catalyst, as well as the electrochemical potential.

FIG. 2 shows the relative effect of catalyst at various potentials. As can be seen in this plot, high surface area carbon black (the main constituent of commonly used MPLS) catalyzes a significant fraction of the reaction product between oxygen and hydrogen into hydrogen peroxide under the anode conditions observed in a typical PEM fuel cell.

It has been reported in the literature that hydrogen peroxide will promote degradation of the ionomer (in the membrane and also in the electrode), particularly in the presence of cations such as iron (see, e.g., A. B. LaConti et al., “Handbook of Fuel Cells” (Eds. W. Vielstich et al.): Wiley (2003), vol. 3(9) 647). The major ionomer decomposition product is hydrofluoric acid (HF). In regions of the MEA, where active reactant gas flows are applied via the flow-field gas channels, the concentration of both H₂O₂ (formed by O₂ crossover to the anode) and HF (from membrane degradation) are kept low as these species are continuously being removed by the reactant gas streams. On the other hand, in areas of the bipolar plate where stagnant flow regions exist (e.g., manufacturing-related indentations (referred to as “dimples”) without active flow, regions along the MEA perimeter where there are no more flow-field channels, and/or any region of the active area of a bipolar plate that does not permit continuous flow of reactive gases during fuel cell operation) the concentration of both H₂O₂ and HF can increase substantially, thus forming a severe corrosive environment for metallic bipolar plates, for many of the typically applied coatings (e.g., metal oxides, metal nitrides, and/or the like), and for bipolar plate seal materials.

It has also been reported in the literature that the corrosion of stainless steels in acidic HF solutions increases rapidly with fluoride concentration; similarly, the corrosion of stainless steels in acidic H₂O₂ and acidic HF/H₂O₂ solutions increases with hydrogen peroxide concentration (see, e.g., N. Laycock et al., Corrosion Science, Vol. 37, No. 10, pp. 1637-1642 (1995); T. Hayward et al., J. Supercritical Fluids, Vol. 27, pp. 275-281 (2003); G. Bellanger, J. Nuclear Materials, Vo. 210, pp. 63-72 (1994); Y. Kim et al., NDT&E International, Vol. 36, pp. 553-562 (2003); and H. Anzai et al., Corrosion Science, Vo. 36, No. 7, pp. 1201-1211 (1994)). Once stainless steel corrosion begins, iron cations will be liberated and will accelerate ionomer degradation which in turn increases the concentration of HF. This constitutes an auto-catalytic process by which liberated HF accelerates stainless steel corrosion which in turn further accelerates membrane degradation, thereby accelerating additional corrosion of the bipolar plate.

It is also known in the art that the crossover of both oxygen to the anode side, as well as the crossover of hydrogen to the cathode side, leads to increased ionomer degradation, producing higher amounts of HF. In stagnant flow regions (i.e., regions outside the active area flow-field channels, in dimple regions, regions of reduced gas flow, and/or the like), this increased HF formation will lead to high concentrations of HF which in turn will accelerate the corrosion of metallic bipolar plates (and of many typically used protective coatings and bipolar plate seal materials).

Accordingly, there exists a need for new and improved fuel cells, including but not limited to new and improved bipolar plates, membrane electrode assembly designs, and/or MEA/MPL configurations that minimize or eliminate stainless steel corrosion.

### SUMMARY OF THE INVENTION

In accordance with the general teachings of the present invention, new and improved membrane electrode assemblies for fuel cells, such as but not limited to PEM fuel cell systems, are provided.

In accordance with one embodiment of the present invention, a membrane electrode assembly for use in conjunction with a fuel cell is provided, comprising: (1) an electrically conductive member having a region of stagnant flow; (2) a diffusion media layer adjacent to the electrically conductive member; (3) a membrane layer; (4) at least one catalyst layer adjacent to the membrane layer, wherein the at least one catalyst layer is adjacent to the diffusion media layer, wherein the at least one catalyst layer is spaced away from the region of stagnant flow; and (5) at least one subgasket layer adjacent to the membrane layer, wherein the at least one subgasket layer is adjacent to the diffusion media layer, wherein the at least one subgasket layer is in proximity to the region of stagnant flow, wherein the at least one catalyst layer and the at least one subgasket layer are spaced away from one another.

In accordance with a first alternative embodiment of the present invention, a membrane electrode assembly for use in conjunction with a fuel cell is provided, comprising: (1) an electrically conductive member having a region of stagnant flow; a diffusion media layer adjacent to the electrically conductive member; (2) a membrane layer; (3) a pair of catalyst layers disposed about the membrane layer, wherein one of the catalyst layers is adjacent to the diffusion media layer, wherein the pair of catalyst layers are spaced away from the region of stagnant flow; and (4) a pair of subgasket layers disposed about the membrane layer, wherein one of the subgasket layers is adjacent to the diffusion media layer, wherein the pair of subgasket layers are in proximity to the region of stagnant flow, wherein the pair of catalyst layers and pair of subgasket layers is spaced away from one another.

In accordance with a second alternative embodiment of the present invention, a fuel cell is provided, comprising: (1) a conductive member having first and second free-flowing channels formed therein and first and second land areas formed about the second free-flowing channel, wherein the conductive member is substantially free of regions of stagnant flow; (2) a diffusion media layer adjacent to the electrically conductive member, a portion of the diffusion media layer overlapping the second land area; (3) a membrane layer; (4) at least one catalyst layer adjacent to the membrane layer, wherein the at least one catalyst layer is adjacent to the diffusion media layer, wherein the at least one catalyst layer is spaced away from the second land area; and (5) at least one subgasket layer adjacent to the membrane layer, wherein the at least one subgasket layer is adjacent to and at least partially overlaps the diffusion media layer in proximity to the second land area, wherein the at least one catalyst layer and the at least one subgasket layer are spaced away from one another.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of the local electrochemistry occurring across the MEA as a result of oxygen and/or hydrogen permeation through the membrane, in accordance with the prior art;

FIG. 2 is a graphical illustration of the quantities of peroxide formation in the presence of carbon black and platinum, in accordance with the prior art;

FIG. 3a is a schematic illustration of a first type of fuel cell, in accordance with one embodiment of the present invention;

FIG. 3b is a schematic illustration of a second type of fuel cell, in accordance with a first alternative embodiment of the present invention;

FIG. 3c is a schematic illustration of a third type of fuel cell, in accordance with a second alternative embodiment of the present invention;

FIG. 3d is a schematic illustration of a fourth type of fuel cell, in accordance with a third alternative embodiment of the present invention;

FIG. 3e is a schematic illustration of a fifth type of fuel cell, in accordance with a fourth alternative embodiment of the present invention;

FIG. 4a is a schematic illustration of a sixth type of fuel cell, in accordance with a fifth alternative embodiment of the present invention;

FIG. 4b is a schematic illustration of a seventh type of fuel cell, in accordance with a sixth alternative embodiment of the present invention;

FIG. 4c is a schematic illustration of an eighth type of fuel cell, in accordance with a seventh alternative embodiment of the present invention; and

FIG. 4d is a schematic illustration of a ninth type of fuel cell, in accordance with an eighth alternative embodiment of the present invention.

### DETAILED DESCRIPTION OF THE EMBODIMENTS

The following description of the preferred is merely exemplary in nature and is in no way intended to limit the invention, its application, or uses.

In accordance with the general teachings of the present invention, systems and methods are provided to eliminate or at least reduce the incidence and/or degree of bipolar plate corrosion, especially of those bipolar plates comprised of stainless steel, as well as the elimination or reduction of surface coating degradation (e.g., metal oxides and/or organic coatings (e.g., silicon oxide and/or the like).

By way of a non-limiting example, all areas of the active area of the MEA (i.e., areas which contain proton-conducting membrane, Pt/C catalyst, other fuel cell electrocatalysts known in the art (e.g., Pt alloys/C), and MPL) should have adjacent flow-field channels on both the anode and the cathode side which have actively driven reactant flow, i.e., there must be no stagnant regions like dimples (created by some bipolar plate designs) or extra-wide lands (e.g., flow-fields are made of lands and channels (where the gas flows) and in the perimeter of the MEA, between the last flow field channel and the bipolar plate perimeter seal (e.g., some conventional designs have very wide lands under which there is no actively driven gas flow). The present invention provides this important metallic bipolar plate design criterion to at least reduce or eliminate corrosion.

As previously noted, due to the very strongly acidic nature of proton-conducting polymers (pH values of 0±1), accelerated stainless steel corrosion occurs wherever proton-conducting ionomers are in direct contact with the metallic bipolar plate. Accordingly, the present invention provides MEAs that are configured such that the proton-conducting polymer is never in direct contact with the metallic bipolar plate, no matter whether there is a stagnant flow region or not. This can be achieved by applying non-proton-conducting protective films (e.g., subgaskets) to these regions. These subgaskets preferably have also reduced permeability compared to the proton-conducting membrane. Possible materials include, without limitation, KAPTON® (e.g., polyimides), MYLAR®, polyethylene naphthalate, ethylene tetrafluoroethylene, polyvinylidene fluoride, polyester, polyamide, co-polyamide, polyamide elastomer, polyurethanes, polyurethane elastomer and any other non-proton-conducting films or coatings. Additionally, the subgaskets can be comprised of non-corrosive metallic materials, such as but not limited to gold and/or the like.

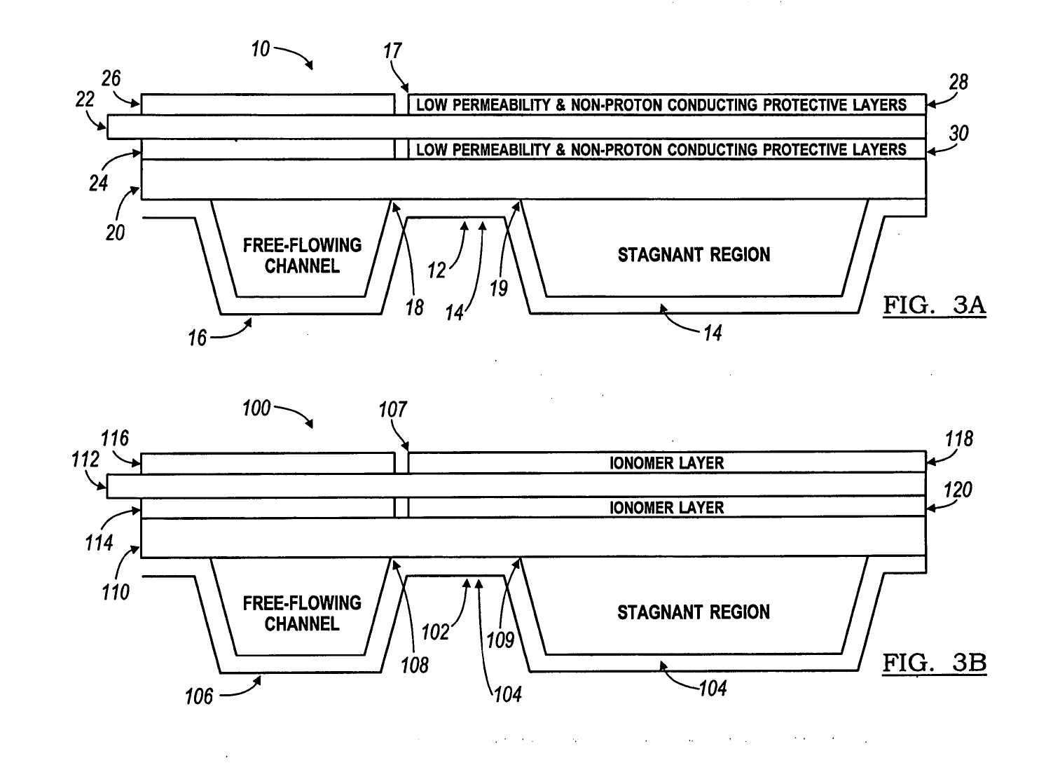

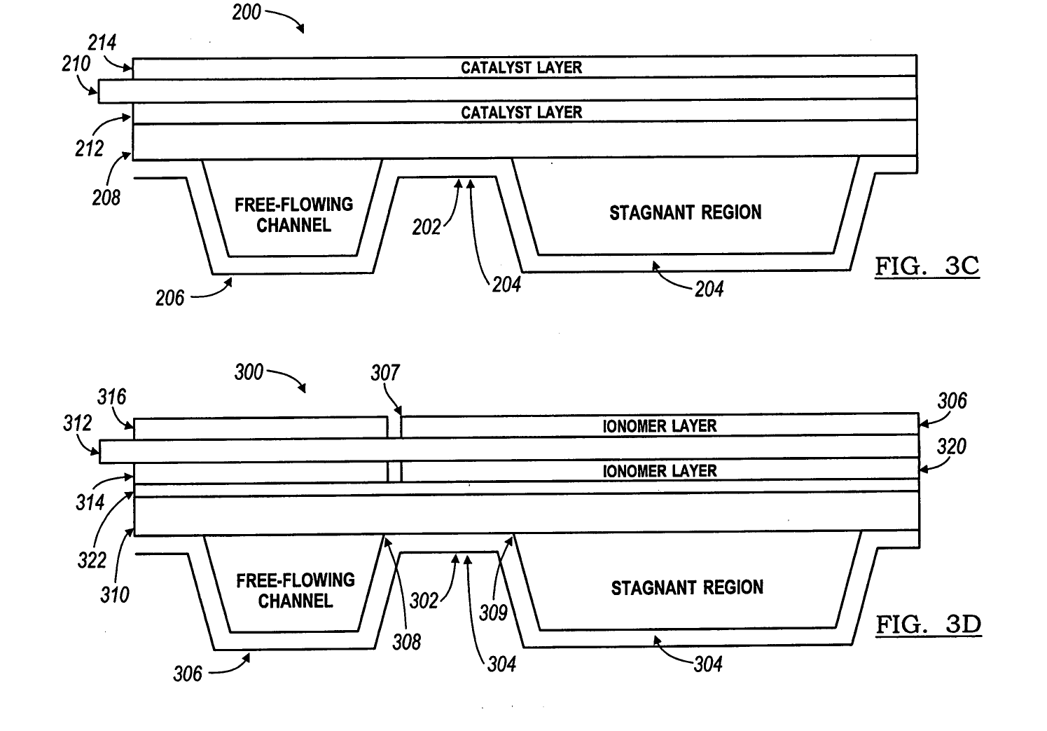

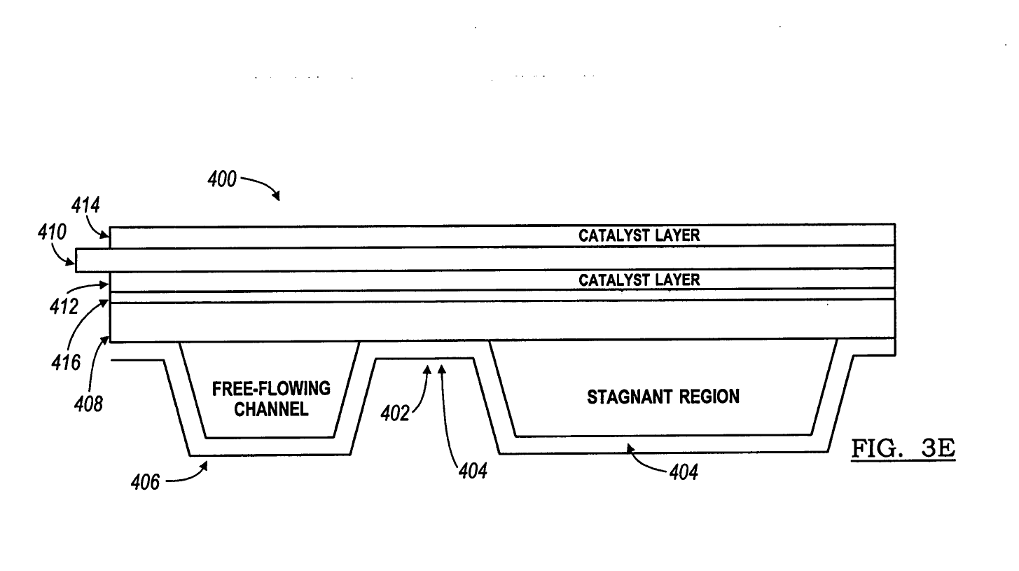

In accordance with still another aspect of the present invention, it has been discovered that when the amount of corroding species present in certain regions of a metallic bipolar plate were varied, it was determined that more or less metal corrosion was obtained. Referring to FIGS. 3a-e, the present invention provides several fuel cells designs incorporating several alternative membrane electrode assembly (MEA) subgasket materials and designs, involving, among other things, geometric arrangements of the subgasket that, among other things, reduce oxygen permeation from the cathode to the anode side of the membranes and/or reduce hydrogen permeation from the anode to the cathode side of the membranes, and preferably reduce both oxygen and hydrogen permeation.

In addition to using protonically and non-conductive subgasket materials with lower oxygen permeation rates versus ionomeric subgaskets which are protonically conducting and have high O₂ and/or H₂ permeation rates, the present invention provides that the elimination of the microporous layer (e.g., coated onto the diffusion medium) directly beneath the permeable subgasket materials will also reduce production of corrosive species.

If the above MEA features are incorporated along with controlling the concentration of corrosive species at certain geometric features on the bipolar plate where flow stagnation may occur, corrosion is reduced. Another benefit of changes in MEA is the potential for eliminating direct contact between the bipolar plate material surface and PFSA ionomer membrane material which has been determined to cause high rates of corrosion to metal bipolar plates.

From the above mechanisms, the following design rules apply.

The preferred option is that a protonically non-conductive subgasket with zero/minimal O₂ and/or H₂ permeability is applied in all regions of stagnant flow (e.g., dimple regions occurring in typical stamped bipolar plates, perimeter regions with wide land regions, and/or the like). Furthermore, diffusion media in stagnant flow regions should not have a high surface area carbon coating (i.e., a MPL). In this manner, no electrochemical reduction of O₂ to H₂O₂ can occur. This option is specifically shown in FIG. 3a, which exhibited no stainless steel plate corrosion in durability testing of a stainless steel short stack.

In this view, the fuel cell 10 includes an electrically conductive member such as but not limited to a bipolar plate 12 (e.g., a metal such as but not limited to stainless steel) having a region of stagnant flow 14 (e.g. a dimpled area, a poorly flowing channel in the active area, a wide land region between free-flowing channels, and/or the like). A free-flowing channel 16 is provided adjacent to the region of stagnant flow. The geometric arrangement of subgasket edge 17 is advantageous if the subgasket edge 17 lies in between the active flow-field edge 18 and the stagnant region edge 19. A wide land is defined herein as any distance between active-flow edge 18 and stagnant region edge 19 provided it is larger than one half of the width of the land in the flow field. It is preferred that subgasket edge 17 is between stagnant region edge 19 and active flow-field edge 18 but not more than one half of a land width away from active flow-field edge 18. It is more preferred if subgasket edge 17 reaches up to active flow-field edge 18. This applies also to some of the other embodiments as well.

A diffusion media component 20 is adjacent to the bipolar plate 12. A membrane 22 is disposed between a pair of catalyst layers 24, 26, respectively, wherein catalyst layer 24 is adjacent to the diffusion media component 20. The catalyst layers 24, 26, respectively, are spaced away from the dimpled area 14. A pair of subgasket layers 28, 30, respectively, is disposed about the membrane 22 in proximity to the dimpled area 14. The subgasket material can be comprised of any type of protonically non-conductive materials. In this view, the subgasket is comprised of the “PEN” type (i.e., polyethylene naphthalate); however, it should be appreciated that the subgasket can be comprised of any suitable polymeric materials, as previously described.

It should be appreciated that the subgasket can be comprised of a discrete layer, a film, a coating, and/or the like. An adhesive material can be employed to promote adhesion to any adjacent layers and/or materials (e.g., the membrane, DM, and/or the like).

For example, when a NAFION® PFSA membrane such as N112® is used as the membrane, the non-proton-conducting, reduced-permeability subgasket or film or coating should have a permeability to oxygen less than 3500 cc-mil/(100 in²-24 hr-atm) at 77° F./100% RH. Preferably, the reduced-permeability subgasket/film/coating should have an oxygen permeability less than or equal to 200 cc-mil/(100 in²-24 hr-atm) at 77° F./100% RH. A preferable material for achieving such a permeability is, for example, ethylene tetrafluoroethylene (ETFE) which has a oxygen permeability of 184 cc-mil/(100 in²-24 hr-atm) at 77° F./100% RH. Most preferably, the reduced-permeability subgasket/film/coating should have an oxygen permeability less than or equal to 25 cc-mil/(100 in²-24 hr-atm) at 77° F./100% RH. Suitable materials that achieve the most preferable oxygen permeability are, by way of a non-limiting example, polyimide (sold under the trade name KAPTON®: 25 cc-mil/(100 in²-24 hr-atm) at 77° F./100% RH), polyvinylidene fluoride (PVDF: 3.4 cc-mil/(100 in²-24 hr-atm) at 77° F./100% RH), and/or the like.

The permeability to hydrogen in the reduced-permeability subgasket/film/coating should be less than 1.5×10⁻⁸ ml(STP)-cm_{thick}/(s-cm²-cm_{Hg}) at 80° C., 270 kPa, 100% RH; preferably less than or equal to 1×10⁻⁹ ml(STP)-cm_{thick}/(s-cm²-cm_{Hg}) at 80° C., 270 kPa, 100% RH; and most preferably less than or equal to 5×10⁻¹⁰ ml(STP)-cm_{thick}/(s-cm²-cm_{Hg}) at 80° C., 270 kPa, 100% RH. Suitable materials for achieving the above hydrogen permeabilities include, without limitation, KAPTON® (4.7×10⁻¹⁰ ml(STP)-cm_{thick}/(s-cm²-cm_{Hg}) at 80° C., 270 kPa, 100% RH) and polyethylene naphthalate (PEN, 2×10⁻¹⁰ ml(STP)-cm_{thick}/(s-cm²-cm_{Hg}) at 80° C., 270 kPa, 100% RH).

A variation of this embodiment includes an MEA edge design configuration having a non-proton-conducting subgasket/film/coating that can still have oxygen and hydrogen permeabilities similar to the proton-conducting membrane. Because this subgasket/film/coating does not provide protons required for the electrochemical reaction of crossover oxygen on the anode side to H₂O₂, it will to a large extent reduce metallic bipolar plate corrosion.

If the above protonically non-conductive subgasket cannot be used in stagnant flow regions, stainless steel bipolar plate corrosion can be reduced if the diffusion medium in these regions has no MPL and no Pt/C catalyst. This would be the case if an ionomeric subgasket is used and the catalyst layer and MPL is pulled back from stagnant flow regions, as is specifically shown in FIG. 3b. This option showed minimum corrosion in short stack testing of a stainless steel bipolar plate test.

In this view, the fuel cell 100 includes an electrically conductive member such as but not limited to a bipolar plate 102 (e.g., a metal such as but not limited to stainless steel) having a dimpled area 104, corresponding to a region of stagnant flow. A free-flowing channel 106 is provided adjacent to the region of stagnant flow. This embodiment also includes a subgasket edge 107, an active flow-field edge 108, and a stagnant region edge 109. A diffusion media component 110 is adjacent to the bipolar plate 102. A membrane 112 is disposed between a pair of catalyst layers 114, 116, respectively, wherein catalyst layer 114 is adjacent to the diffusion media component 110. The catalyst layers 114, 116, respectively, are spaced away from the dimpled area 104. A pair of subgasket layers 118, 120, respectively, is disposed about the membrane 112 in proximity to the dimpled area 104. In this view, the subgasket is comprised of the ionomer-type materials.

If neither of the above two design options can be applied, an MPL over stagnant flow regions should at minimum be avoided, as is specifically shown in FIG. 3c.

In this view, the fuel cell 200 includes an electrically conductive member such as but not limited to a bipolar plate 202 (e.g., a metal such as but not limited to stainless steel) having a dimpled area 204, corresponding to a region of stagnant flow. A free-flowing channel 206 is provided adjacent to the region of stagnant flow. A diffusion media component 208 is adjacent to the bipolar plate 202. A membrane 210 is disposed between a pair of catalyst layers 212, 214, respectively, wherein catalyst layer 212 is adjacent to the diffusion media component 208. The catalyst layers 212, 214, respectively, are in proximity to the dimpled area 204.

Additionally, having MPL in contact with an inomeric membrane or subgasket over stagnant flow regions (e.g., as specifically shown in FIG. 3d, leads to major corrosion of stainless steel bipolar plates and should also be avoided.

In this view, the fuel cell 300 includes an electrically conductive member such as but not limited to a bipolar plate 302 (e.g., a metal such as but not limited to stainless steel) having a dimpled area 304, corresponding to a region of stagnant flow. A free-flowing channel 306 is provided adjacent to the region of stagnant flow. This embodiment also includes a subgasket edge 307, an active flow-field edge 308, and a stagnant region edge 309. A diffusion media component 310 is adjacent to the bipolar plate 302. A membrane 312 is disposed between a pair of catalyst layers 314, 316, respectively, wherein catalyst layer 314 is adjacent to the diffusion media component 310. The catalyst layers 314, 316, respectively, are spaced away from the dimpled area 304. A pair of subgasket layers 318, 320, respectively, is disposed about the membrane 312 in proximity to the dimpled area 304. Additionally, MPL 322 is disposed between the diffusion media component 310 and catalyst layer 314/subgasket layer 318. In this view, the subgasket is comprised of the ionomer-type materials.

Furthermore, having Pt/C catalyst between the membrane and a MPL over stagnant flow regions (as specifically shown in FIG. 3e) still leads to significant corrosion, although it is slightly better than the case without the use of Pt/C catalyst.

In this view, the fuel cell 400 includes an electrically conductive member such as but not limited to a bipolar plate 402 (e.g., a metal such as but not limited to stainless steel) having a dimpled area 404, corresponding to a region of stagnant flow. A free-flowing channel 406 is provided adjacent to the region of stagnant flow. A diffusion media component 408 is adjacent to the bipolar plate 402. A membrane 410 is disposed between a pair of catalyst layers 412, 414, respectively, wherein catalyst layer 412 is adjacent to the diffusion media component 408. The catalyst layers 412, 414, respectively, are in proximity to the dimpled area 404. Additionally, MPL 416 is disposed between the diffusion media component 408 and catalyst layer 412.

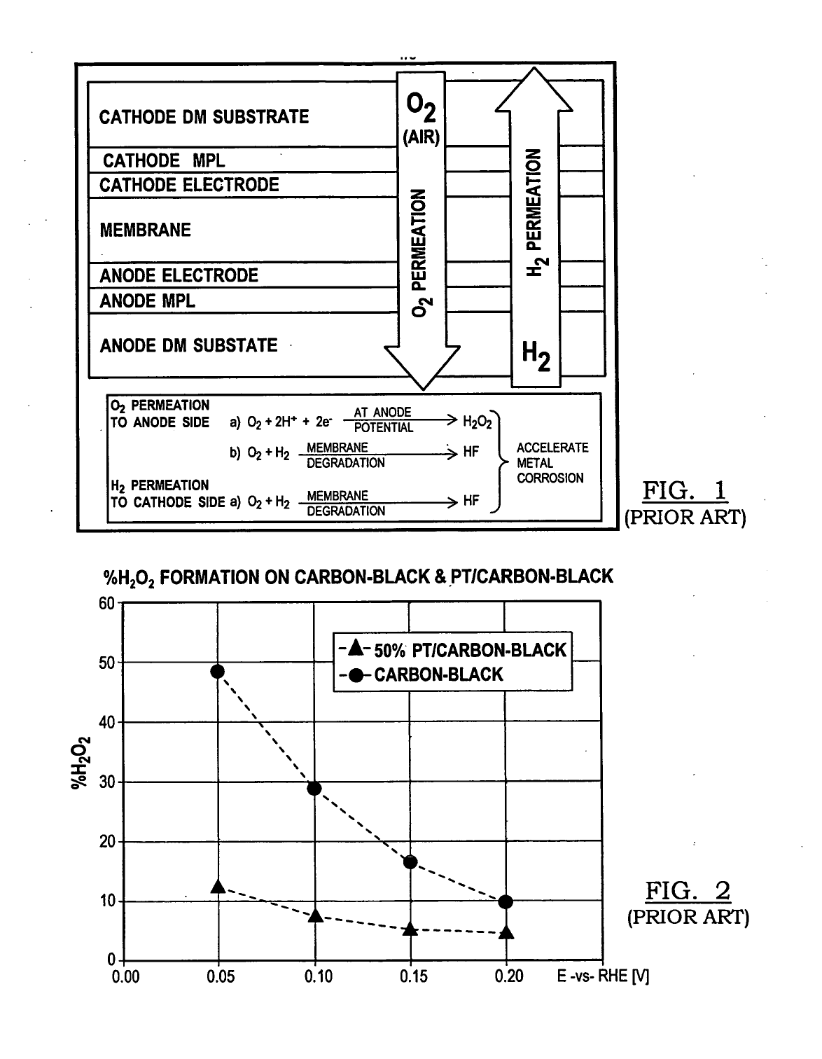

In summary, stagnant flow regions should either be free of crossover O₂ by means of using an impermeable subgasket, or should not have any substance that catalyzes H₂O₂ formation from O₂ (e.g., high surface area carbon), produces HF from either O₂ and/or H₂ permeation, or should have a subgasket which is protonically non-conductive. This is based on the principle that the H₂O₂ formation reaction of O₂ on the anode (i.e., at low electrode potentials of 0-0.2V versus the reversible hydrogen reference potential) can be written as O₂+2H+2e→H₂O₂ (as noted in FIG. 1). Additionally, O₂ permeation to the anode side can yield HF, via the following reaction: (O₂+H₂→HF) (as noted in FIG. 1). Furthermore, H2 permeation to the cathode side can also yield HF, via the following reaction: (O₂+H₂→HF) (as noted in FIG. 1). The present invention eliminates or at least reduces the formation of these corrosive species.

This reaction shows that H₂O₂ can only be formed if O₂ and H⁺ are available simultaneously on a catalytically active surface (e.g., high surface area carbon). If subgaskets either inhibit O₂ permeation and/or H⁺ conduction, or if catalytically active substances are omitted from stagnant flow regions (e.g., a MPL or, to a lesser degree Pt/C), H₂O₂ cannot be formed and no or little stainless steel corrosion will be observed.

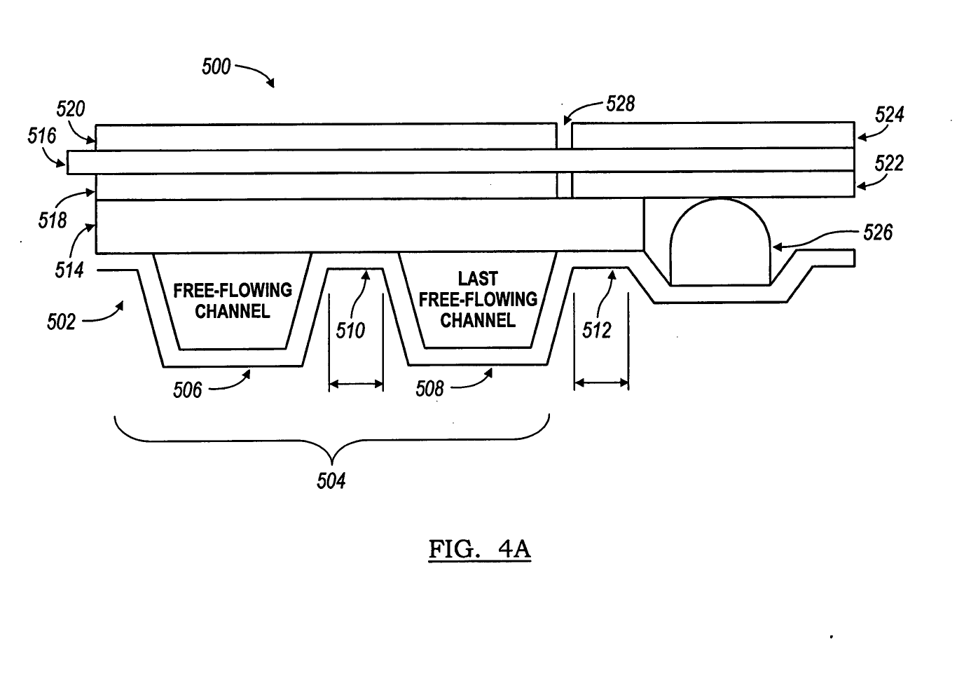

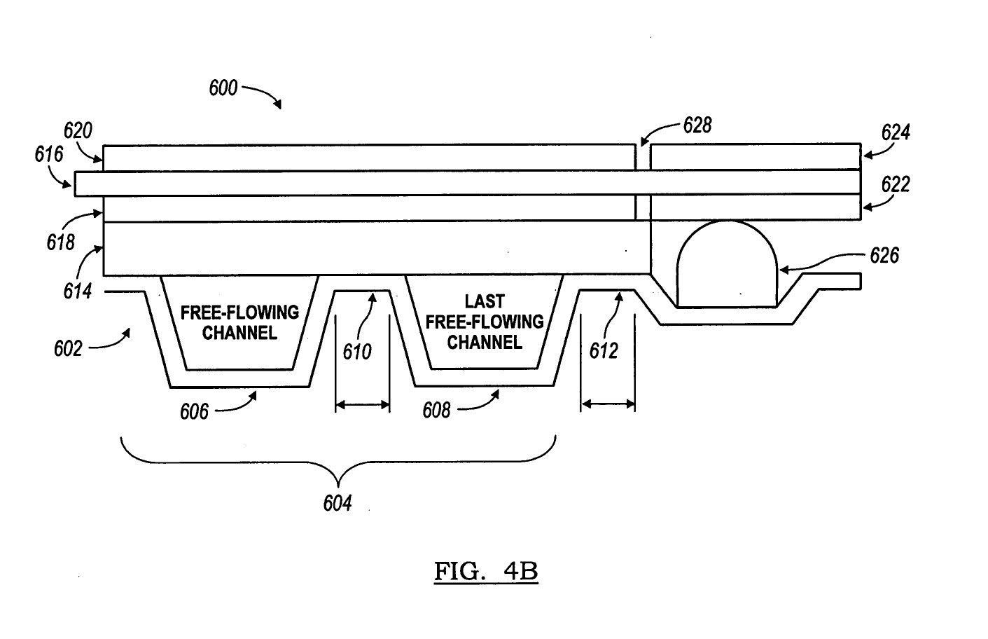

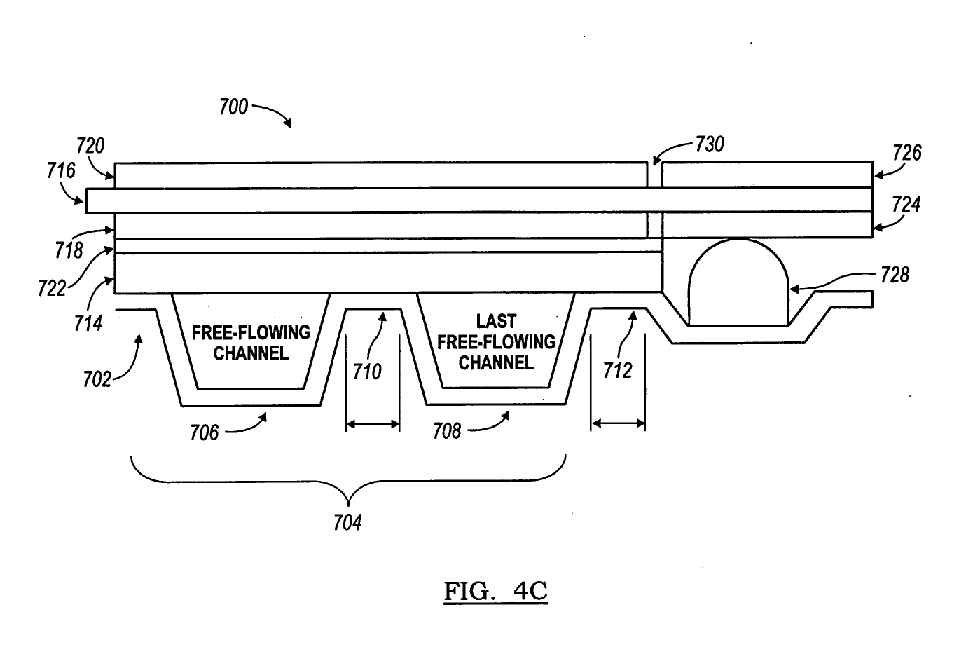

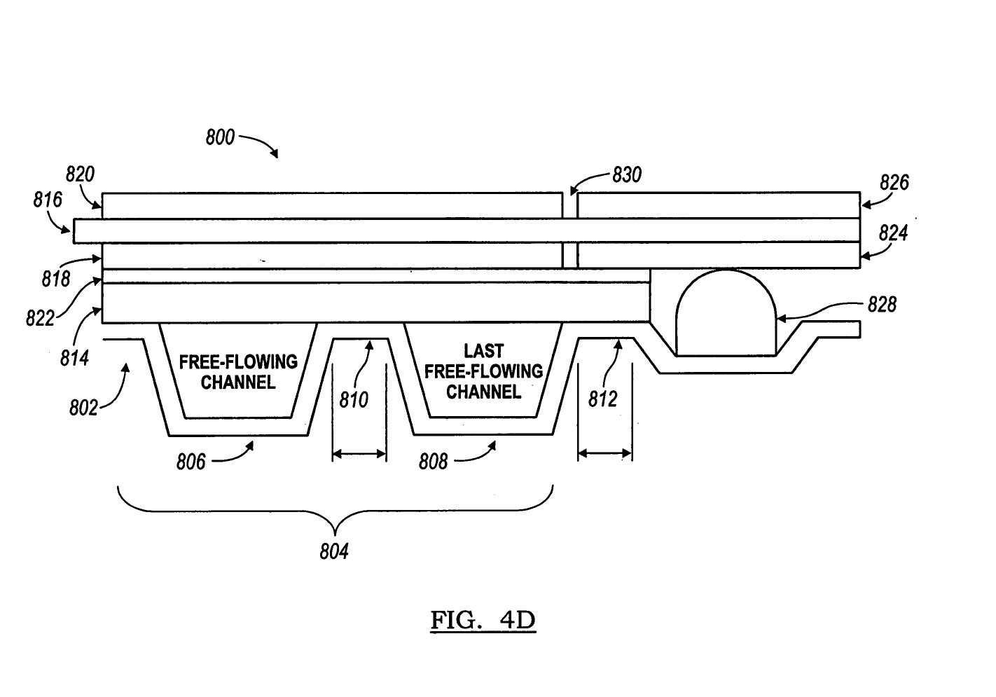

In accordance with another aspect of the present invention, if bipolar plates are designed without the presence of features which permit stagnation of product water and/or other reaction products from normal fuel cell operation, then corrosion of the bipolar plate will be reduced or eliminated. If such features are necessary for fuel cell operation then their locations, e.g., with respect to subgasket, microporous layers, and MEA catalyst, should permit co-location of either platinum catalyst or a subgasket material possessing low permeation to oxygen and/or hydrogen that will limit peroxide and/or HF formation. Additionally, corrosion of the coatings will also be eliminated and/or reduced. The various components of these types of fuel cells can be comprised of materials as previously described herein. Furthermore, the characteristics and performance of these components can be similar or identical to those components as previously described herein. An example of this particular aspect of the present invention is shown in FIG. 4a.

In this view, the fuel cell 500 includes an electrically conductive member such as but not limited to a bipolar plate 502 (e.g., a metal such as but not limited to stainless steel) having an active area flowfield 504. The flow field includes at least two free-flowing channels, 506, 508, respectively, having a land area 510 located therebetween. Another land area 512 is located after the last free-flowing channel 508. The width/length/distance of the land area 512 should be smaller than, and preferably no more than half, of the width/length/distance of the last free-flowing channel 508. More preferably, the width/length/distance of the land area 512 should approach zero. The terms “width,” “length,” and “distance,” as used interchangeably herein are meant to encompass any relative comparison of the dimensions, regardless of direction or orientation, of one point to a second spaced point.

A diffusion media component 514 is adjacent to the bipolar plate 502. A membrane 516 is disposed between a pair of catalyst layers 518, 520, respectively, wherein catalyst layer 518 is adjacent to the diffusion media component 514. The catalyst layers 518, 520, respectively, are disposed over the active area flowfield 504. A pair of subgasket layers 522, 524, respectively, is disposed about the membrane 516 in proximity to land area 512. The subgasket material can be comprised of any type of protonically non-conductive materials, as previously described. An optional seal member 526 is also shown.

The geometric arrangement of subgasket edge 528 is advantageous if the subgasket edge 528 lies in between the edge of the last free-flowing channel 508 and the land area 512.

An example of another embodiment of this particular aspect of the present invention is shown in FIG. 4b.

In this view, the fuel cell 600 includes an electrically conductive member such as but not limited to a bipolar plate 602 (e.g., a metal such as but not limited to stainless steel) having an active area flowfield 604. The flow field includes at least two free-flowing channels, 606, 608, respectively, having a land area 610 located therebetween. Another land area 612 is located after the last free-flowing channel 608. The width/length/distance of the land area 612 should be smaller than, and preferably no more than half, of the width/length/distance of the last free-flowing channel 608. More preferably, the width/length/distance of the land area 612 should approach zero.

A diffusion media component 614 is adjacent to the bipolar plate 602. A membrane 616 is disposed between a pair of catalyst layers 618, 620, respectively, wherein catalyst layer 618 is adjacent to the diffusion media component 614. The catalyst layers 618, 620, respectively, are disposed over the active area flowfield 604. A pair of subgasket layers 622, 624, respectively, is disposed about the membrane 616 in proximity to an edge portion of the land area 612, i.e., neither of subgasket layers 622, 624, respectively, overlap the area corresponding to land area 612. The subgasket material can be comprised of any type of protonically non-conductive materials, as previously described. An optional seal member 626 is also shown.

The geometric arrangement of subgasket edge 628 is advantageous if the subgasket edge 628 lies outside of the edge portion of the land area 612.

An example of another embodiment of this particular aspect of the present invention is shown in FIG. 4c. However, having MPL near or in contact with an inomeric membrane or subgasket can lead to major corrosion of stainless steel bipolar plates and should be avoided.

In this view, the fuel cell 700 includes an electrically conductive member such as but not limited to a bipolar plate 702 (e.g., a metal such as but not limited to stainless steel) having an active area flowfield 704. The flow field includes at least two free-flowing channels, 706, 708, respectively, having a land area 710 located therebetween. Another land area 712 is located after the last free-flowing channel 708. The width/length/distance of the land area 712 should be smaller than, and preferably no more than half, of the width/length/distance of the last free-flowing channel 708. More preferably, the width/length/distance of the land area 712 should approach zero.

A diffusion media component 714 is adjacent to the bipolar plate 702. A membrane 716 is disposed between a pair of catalyst layers 718, 720, respectively, wherein catalyst layer 718 is adjacent to the diffusion media component 714. The catalyst layers 718, 720, respectively, are disposed over the active area flowfield 704 as well as the land area 712. Additionally, MPL 722 is disposed between the diffusion media component 714 and catalyst layer 718. A pair of subgasket layers 724, 726, respectively, is disposed about the membrane 716 in proximity to an edge portion of the land area 712, i.e., neither of subgasket layers 724, 726, respectively, overlap the area corresponding to land area 712. The subgasket material can be comprised of any type of protonically non-conductive materials, as previously described. An optional seal member 728 is also shown.

The geometric arrangement of subgasket edge 730 is advantageous if the subgasket edge 730 lies at least partially within the land area 712 and at least partially overlaps MPL 722.

An example of another embodiment of this particular aspect of the present invention is shown in FIG. 4d. However, having MPL in contact with an inomeric membrane or subgasket, can lead to major corrosion of stainless steel bipolar plates and should be avoided.

In this view, the fuel cell 800 includes an electrically conductive member such as but not limited to a bipolar plate 802 (e.g., a metal such as but not limited to stainless steel) having an active area flowfieid 804. The flow field includes at least two free-flowing channels, 806, 808, respectively, having a land area 810 located therebetween. Another land area 812 is located after the last free-flowing channel 808. The width/length/distance of the land area 812 should be smaller than, and preferably no more than half, of the width/length/distance of the last free-flowing channel 808. More preferably, the width/length/distance of the land area 812 should approach zero.

A diffusion media component 814 is adjacent to the bipolar plate 802. A membrane 816 is disposed between a pair of catalyst layers 818, 820, respectively, wherein catalyst layer 818 is adjacent to the diffusion media component 814. The catalyst layers 818, 820, respectively, are disposed over the active area flowfield 804 as well as the land area 812. Additionally, MPL 822 is disposed between the diffusion media component 814 and catalyst layer 818. A pair of subgasket layers 824, 826, respectively, is disposed about the membrane 816 in proximity to the land area 812, i.e., the subgasket layers 824, 826, respectively, overlap and contact MPL 822. The subgasket material can be comprised of any type of protonically non-conductive materials, as previously described. An optional seal member 828 is also shown.

The geometric arrangement of subgasket edge 830 is advantageous if the subgasket edge 830 lies at least partially within the land area 812 and at least partially overlaps MPL 822.

It should be appreciated that any of the features and characteristics of the various aforementioned embodiments can be used in conjunction with one another in any number of combinations.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fuel cell, comprising:
a conductive member having a region of stagnant flow;
a diffusion media layer adjacent to the electrically conductive member;
a membrane layer;
at least one catalyst layer adjacent to the membrane layer, wherein the at least one catalyst layer is adjacent to the diffusion media layer, wherein the at least one catalyst layer is spaced away from the region of stagnant flow; and
at least one subgasket layer adjacent to the membrane layer, wherein the at least one subgasket layer is adjacent to the diffusion media layer, wherein the at least one subgasket layer is in proximity to the region of stagnant flow, wherein the at least one catalyst layer and the at least one subgasket layer are spaced away from one another.

2. The invention according to claim 1, wherein the conductive member is a bipolar plate.

3. The invention according to claim 1, wherein the conductive member is comprised of a metallic material.

4. The invention according to claim 1, wherein the conductive member is comprised of stainless steel.

5. The invention according to claim 1, wherein the subgasket layer is comprised of a non-conductive material.

6. The invention according to claim 1, wherein the subgasket layer is comprised of a protonically non-conductive material.

7. The invention according to claim 1, wherein the subgasket layer is comprised of a material having substantially low oxygen permeability.

8. The invention according to claim 1, wherein the subgasket layer is comprised of a material having substantially low hydrogen permeability.

9. The invention according to claim 1, wherein the subgasket layer is comprised of a material selected from the group consisting of a polymeric material, a non-corrosive metallic material, and combinations thereof.

10. The invention according to claim 1, further comprising a pair of catalyst layers.

11. The invention according to claim 1, further comprising a pair of subgasket layers.

12. The invention according to claim 1, wherein the region of stagnant flow comprises a region selected from the group consisting of a dimpled area formed on the electrically conductive member, a wide land at the periphery of a membrane electrode assembly, and combinations thereof.

13. The invention according to claim 1, further comprising a microporous layer disposed between the diffusion media layer and at least one of the catalyst layer and the subgasket layer.

14. The invention according to claim 1, wherein the conductive member does not contact the membrane layer.

15. A fuel cell, comprising:
a conductive member having a region of stagnant flow;
a diffusion media layer adjacent to the electrically conductive member;
a membrane layer;
a pair of catalyst layers disposed about the membrane layer, wherein one of the catalyst layers is adjacent to the diffusion media layer, wherein the pair of catalyst layers are spaced away from the region of stagnant flow; and
a pair of subgasket layers disposed about the membrane layer, wherein one of the subgasket layers is adjacent to the diffusion media layer, wherein the pair of subgasket layers are in proximity to the region of stagnant flow, wherein the pair of catalyst layers and pair of subgasket layers is spaced away from one another.

16. The invention according to claim 15, wherein the conductive member is a bipolar plate.

17. The invention according to claim 15, wherein the conductive member is comprised of a metallic material.

18. The invention according to claim 15, wherein the conductive member is comprised of stainless steel.

19. The invention according to claim 15, wherein the subgasket layer is comprised of a non-conductive material.

20. The invention according to claim 15, wherein the subgasket layer is comprised of a protonically non-conductive material.

21. The invention according to claim 15, wherein the subgasket layer is comprised of a material having substantially low oxygen permeability.

22. The invention according to claim 15, wherein the subgasket layer is comprised of a material having substantially low hydrogen permeability.

23. The invention according to claim 15, wherein the subgasket layer is comprised of a material selected from the group consisting of a polymeric material, a non-corrosive metallic material, and combinations thereof.

24. The invention according to claim 15, wherein the region of stagnant flow comprises a region selected from the group consisting of a dimpled area formed on the electrically conductive member, a wide land at the periphery of a membrane electrode assembly, and combinations thereof.

25. The invention according to claim 15, further comprising a microporous layer disposed between the diffusion media layer and at least one of the pair of catalyst layers and the pair of subgasket layers.

26. The invention according to claim 15, wherein the conductive member does not contact the membrane layer.

27. A fuel cell, comprising:
a conductive member having first and second free-flowing channels formed therein and first and second land areas formed about the second free-flowing channel, wherein the conductive member is substantially free of regions of stagnant flow;
a diffusion media layer adjacent to the electrically conductive member, a portion of the diffusion media layer overlapping the second land area;
a membrane layer;
at least one catalyst layer adjacent to the membrane layer, wherein the at least one catalyst layer is adjacent to the diffusion media layer, wherein the at least one catalyst layer is spaced away from the second land area; and
at least one subgasket layer adjacent to the membrane layer, wherein the at least one subgasket layer is adjacent to and at least partially overlaps the diffusion media layer in proximity to the second land area, wherein the at least one catalyst layer and the at least one subgasket layer are spaced away from one another.

28. The invention according to claim 27, wherein the conductive member is a bipolar plate.

29. The invention according to claim 27, wherein the conductive member is comprised of a metallic material.

30. The invention according to claim 27, wherein the conductive member is comprised of stainless steel.

31. The invention according to claim 27, wherein the subgasket layer is comprised of a non-conductive material.

32. The invention according to claim 27, wherein the subgasket layer is comprised of a protonically non-conductive material.

33. The invention according to claim 27, wherein the subgasket layer is comprised of a material having substantially low oxygen permeability.

34. The invention according to claim 27, wherein the subgasket layer is comprised of a material having substantially low hydrogen permeability.

35. The invention according to claim 27, wherein the subgasket layer is comprised of a material selected from the group consisting of a polymeric material, a non-corrosive metallic material, and combinations thereof.

36. The invention according to claim 27, further comprising a pair of catalyst layers.

37. The invention according to claim 27, further comprising a pair of subgasket layers.

38. The invention according to claim 27, further comprising a microporous layer disposed between the diffusion media layer and at least one of the catalyst layer and the subgasket layer.

39. The invention according to claim 27, wherein the conductive member does not contact the membrane layer.

40. The invention according to claim 27; wherein the distance of the first or second land areas is less than the distance of the second free-flowing channel.

41. The invention according to claim 27, wherein the distance of the first or second land areas is no more than half of the distance of the second free-flowing channel.
